(19) United States
(12) Patent Application Publication
(10) Pub. No.: US 2022/0146975 A1
(43) Pub. Date: May 12, 2022

(54) IMAGE FORMING SYSTEM, AND CONTROL METHOD FOR IMAGE FORMING SYSTEM

(71) Applicant: CANON KABUSHIKI KAISHA, Tokyo (JP)

(72) Inventors: Rin Ishikawa, Ibaraki (JP); Atsushi Takada, Chiba (JP); Tadashi Iwakawa, Tokyo (JP)

(21) Appl. No.: 17/519,433

(22) Filed: Nov. 4, 2021

(30) Foreign Application Priority Data
Nov. 11, 2020 (JP) 2020-187776

(51) Int. Cl. G03G 15/00; B41J 11/70; B41F 13/54; B41J 15/04

(52) U.S. Cl. CPC G03G 15/6523; B41J 11/70; G03G 2215/00814; B41J 15/04; B41F 13/54

(57) ABSTRACT

An image forming system includes a first unit, a second unit, and a third unit. The first unit includes an image forming unit that forms an image on a sheet fed from a feed unit. The second unit is arranged on a downstream side of the first unit and includes a cutting unit that cuts the sheet on which the image is formed by the image forming unit. The third unit is arranged on a downstream side of the second unit and includes a post-processing unit that post-processes the sheet cut by the cutting unit. A sheet cut to have a first size is discharged to a first discharge unit provided in the second unit. A sheet cut to have a second size larger than the first size is discharged to a second discharge unit provided in the third unit.

### BACKGROUND

### Field

The present disclosure relates to an image forming system and a control method for controlling the image forming system.

### Description of the Related Art

Post-process devices which are arranged downstream of image forming devices such as copiers and printers are widely known, and perform a binding process and the like on output sheets. In recent years, post-process devices have become multifunctional, and some of them are capable of saddle stitching in addition to conventional end stitching. In such a post-process device, however, when an image is formed by an image forming device that is not capable of fringeless printing, a margin area remains on the sheet on which the image is formed.

Against this background, an image forming system having, downstream of the saddle-stitching function, a post-process device provided with a fore edge cutting function for cutting a fore edge portion of a saddle-folded paper bundle has been proposed (see Japanese Patent Application Laid-Open No. 2003-341919).

In order to add further value to a product, an image forming system has been proposed in which a side end portion removal device for trimming a sheet is provided between the image forming device and a finisher unit provided with a saddle stitching processing function (see Japanese Patent Application Laid-Open No. 2016-185849).

According to the configuration of Japanese Patent Application Laid-Open No. 2016-185849, for example, it is also possible to make a small-sized product such as a business card by executing multiple cuts on a single sheet of paper in a side end portion removal device.

In Japanese Patent Application Laid-Open No. 2016-185849, however, after cutting a sheet to the size of a small product such as a business card, the cut sheet is conveyed to a post-process device provided with a saddle-stitching processing function. For this reason, the roller pitch of each pair of rollers that conveys the cut sheet inside the post-process device must be designed to be short enough to accommodate a small-sized product such as business card, which complicates the structure of the device.

### SUMMARY

The present disclosure is directed to providing an image forming system that can make a small-sized product without complicating a device.

According to an aspect of the present disclosure, an image forming system includes a first unit including an image forming unit configured to form an image on a sheet fed from a feed unit, a second unit arranged on a downstream side of the first unit and including a cutting unit configured to cut the sheet on which the image is formed by the image forming unit, and a third unit arranged on a downstream side of the second unit and including a post-processing unit configured to post-process the sheet cut by the cutting unit, wherein a sheet cut to have a first size is discharged to a first discharge unit provided in the second unit, and wherein a sheet cut to have a second size larger than the first size is discharged to a second discharge unit provided in the third unit.

Further features of the present disclosure will become apparent from the following description of exemplary embodiments with reference to the attached drawings.

### BRIEF DESCRIPTION OF THE DRAWINGS

FIG. 1 is a diagram illustrating an overall configuration of an image forming system.

FIG. 2 is a diagram illustrating a partial configuration of a sheet cutting device B.

FIG. 3 is a schematic diagram illustrating a leading/rear end cutter unit.

FIG. 4 is a schematic diagram illustrating a top/bottom cutter unit.

FIG. 5 is a diagram illustrating a configuration of a sheet post-processing device C.

FIG. 6A is a diagram illustrating a partial configuration of the sheet cutting device B (first exemplary embodiment).

FIG. 6B is a diagram illustrating a partial configuration of the sheet cutting device B (first exemplary embodiment).

FIG. 7A is a diagram illustrating a partial configuration of the sheet cutting device B (second exemplary embodiment).

FIG. 7B is a diagram illustrating a partial configuration of the sheet cutting device B (second exemplary embodiment).

FIG. 8 is a diagram illustrating a cutting position when an A4 paper sheet is to be cut into a business card size.

FIG. 9 is a control block diagram of the image forming system.

FIG. 10 is a flowchart of the entire operation from image formation to discharge.

### DESCRIPTION OF THE EMBODIMENTS

With reference to the drawings, each exemplary embodiment for carrying out the present disclosure will be described.

The exemplary embodiments described below are only examples and are not intended to limit the scope of the present disclosure thereto. Not all of the combinations of features described in each of the following exemplary embodiments may be essential to the solution of the present disclosure.

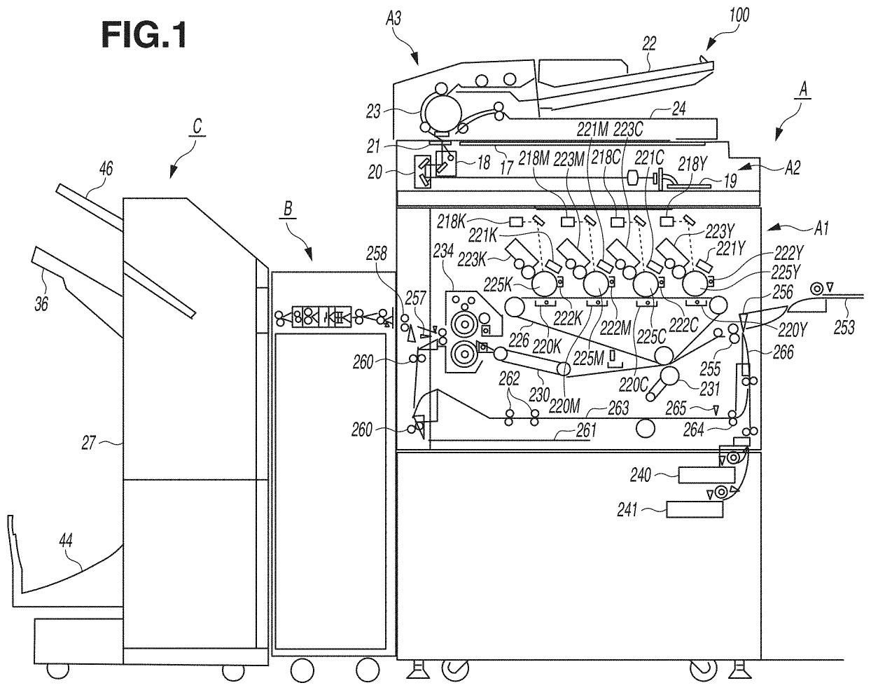

A preferable exemplary embodiment of the present disclosure will now be described in detail with reference to the accompanying drawings. FIG. 1 schematically illustrates an overall configuration of an image forming system provided with a sheet processing device according to a first exemplary embodiment.

As illustrated in FIG. 1, an image forming system 100 is provided with an image forming device A, a sheet cutting device B disposed together with the image forming device A, and a sheet post-processing device C disposed together with the image forming device A. The image forming device A, the sheet cutting device B, and the sheet post-processing device C may be configured as units separate from each other. In other words, a housing of the image forming device A is different from that of the sheet cutting device B. The image forming device A and the sheet cutting device B are detachable from each other. The housing of the sheet cutting device B and a housing of the sheet post-processing device C are different from each other. The sheet cutting device B and the sheet post-processing device C are detachable from each other.

### <Configuration of Image Forming Device A>

An image forming device A is provided with an image forming unit Al, a scanner unit A2, and a feeder unit A3.

The image forming unit Al includes photoreceptor drums (hereinafter referred to as “photoreceptor”) 225Y, 225M, 225C, and 225K for forming full-color electrostatic images. Y, M, C, and K refer to yellow, magenta, cyan, and black, respectively. Primary chargers 221Y, 221M, 221C and 221K, exposure devices 218Y, 218M, 218C and 218K, development devices 223Y, 223M, 223C and 223K, transfer chargers 220Y, 220M, 220C and 220K, and cleaner devices 222Y, 220M, 220C and 220K are arranged around the photoreceptors 225Y, 225M, 225C and 225K.

The development device 223K is a development device for monochrome development, and develops a latent image on the photoreceptor 225K with K toner. The development devices 223Y, 223M and 223C are development devices for full color development. The development devices 223Y, 223M, and 223C develop latent images on the photoreceptors 225Y, 225M and 225C with toners of yellow, magenta, and cyan colors, respectively.

The toner images of respective colors developed on the photoreceptors 225Y, 225M, 225C and 225K are multiple-transferred in a batch onto a transfer belt 226 as an intermediate transfer member by the transfer chargers 220Y, 220M, 220C and 220K, and the toner images of the four colors are superimposed.

A medium (sheet), which is a printing sheet stored in cassettes 240 and 241 or a manual paper feed unit 253 as a feed unit, is fed to a contact portion (nip portion) between a secondary transfer device 231 and the transfer belt 226. The toner image formed on the transfer belt 226 is transferred onto the sheet in the nip portion, thermally fixed by a fixing device 234, and discharged out of the device.

An image forming operation to be performed by the image forming device A configured as described above will now be described.

A sheet conveyance operation to be performed by the paper feed unit is to be described below.

The sheets stored in the cassettes 240 and 241 and the manual paper feed unit 253 are conveyed one by one onto a paper feed path 266. When the sheet on the paper feed path 266 is conveyed to a registration roller 255, the passage of the sheet is detected by a registration sensor 256 immediately before the registration roller 255. According to the present exemplary embodiment, the conveyance operation is suspended after a predetermined time elapses from the time when the passage of the sheet is detected by the registration sensor 256.

As a result, the sheet comes into contact with the stopped registration roller 255, and the conveyance is stopped. In that case, the position is fixed so that the end portion of the sheet in the travelling direction is perpendicular to the conveyance path, and when a skew movement occurs because the conveyance direction of the sheet is misaligned relative to the conveyance path, the paper feed path conveyance direction is corrected. This process is usually referred to as paper feed registration taking. After the paper feed registration taking is performed, the registration roller 255 is started so that the sheet is supplied to the secondary transfer device 231.

The procedure for forming an image on a front surface of a sheet supplied to the secondary transfer device 231 is to be described below.

A voltage is applied to the primary chargers 221Y, 221M, 221C and 221K thereby to uniformly negatively charge the surfaces of the photoreceptors 225Y, 225M, 225C and 225K with a planned charging portion potential. Then, so that the image portion on the charged photoreceptors 225Y, 225M, 225C and 225K are charged with a planned exposure portion potential, the exposure devices 218Y, 218M, 218C and 218K each including a laser scanner portion perform exposing thereby to form latent images. The exposure devices 218Y, 218M, 218C and 218K are turned on and off based on the image signal thereby to form latent images that correspond to the images.

A development bias preset for each color is applied to the development rollers of the development devices 223Y, 223M, 223C and 223K, and the latent image is developed with toner and visualized as a toner image when the latent image is passing through the position of the development roller. The toner image is transferred to the transfer belt 226 by the transfer chargers 220Y, 220M, 220C and 220K, and further transferred to the sheet conveyed from the paper feed unit by the secondary transfer device 231, and then conveyed to a fixing device 234 via a fixing conveyance belt 230. After the toner image is thermally fixed by the fixing device 234, the conveyance path is switched toward the discharge path 258 side by the discharge flapper 257, and the sheet is conveyed to the sheet cutting device B.

The toner remaining on the photoreceptor 225 is removed and collected by the cleaner device 222. Finally, the photoreceptors 225Y, 225M, 225C and 225K are uniformly static-eliminated to around 0 volt by a static-eliminating device (not illustrated) thereby to prepare for the next image forming cycle.

In the image forming unit A1, sheets can be continuously fed from the cassettes 240 and 241 and the manual paper feed unit 253. In this case, the sheet length of the preceding sheets is taken into account, and the sheets are fed from the cassettes 240 and 241 and the manual paper feed unit 253 at the shortest interval such that the sheets do not overlap.

As explained above, after the paper feed registration taking is performed, the registration roller 255 is started so as to supply the sheet to the secondary transfer device 231. At this time, after the preceding sheet has been completely fed to the secondary transfer device 231, the drive transmission from the clutch is stopped so as to pause the registration roller 255.

In order to perform the same feed register taking on a subsequent sheet in the same manner as on a preceding sheet, the registration roller 255 needs to be paused before the subsequent sheet reaches the registration roller 255. For this reason, if focus is placed only on the behavior of the registration roller 255, it is necessary to continuously repeat the following series of operations (1) to (3) in order to continuously perform the image formation on the sheet. That is, (1) the leading end of the sheet reaches the stopped registration roller 255, and the paper feed registration taking is performed, (2) then, the registration roller 255 is started and rotated thereby to feed the sheet to the secondary transfer device 231, and (3) the registration roller 255 is stopped when the feeding is completed.

An operation to form an image on a back surface of a sheet is described in detail.

When an image is to be formed on a back surface of a sheet, image formation on the front surface of the sheet is first executed. Since the image forming operation on a front surface has been described above in detail, description thereof is omitted here.

In a case where image formation on a back surface is executed, the conveyance path is switched toward the back surface path 259 side by the discharge flapper 257. The rotation drive of the reversing roller 260 in conjunction the switching of the conveyance path once conveys the sheet into the double-sided reversing path 261. Then, the sheet is conveyed into a double-sided reversing path 261 by the width of the sheet in the feed direction, and then, the travelling direction is switched by driving the reversing roller 260 for a reverse rotation and driving the double-sided path conveyance roller 262. The sheet is conveyed to the double-sided path 263 with the image formed on the front surface facing downward.

The sheet is then conveyed on the double-sided path 263 toward a refeed roller 264, and the sheet's passage is detected by the refeeding sensor 265 arranged immediately before the refeed roller 264. According to the present exemplary embodiment, the conveyance operation is suspended after a predetermined time elapses from the time when the passage of the sheet is detected by the refeeding sensor 265. As a result, the sheet comes into contact with the stopped refeed roller 264, and conveyance is temporarily stopped. In that case, the position is fixed so that the end portion of the sheet in the travelling direction is perpendicular to the conveyance path, and when a skew movement occurs because the conveyance direction of the sheet is misaligned relative to the conveyance path in the paper refeed path, the paper refeed path conveyance direction is corrected. This process is usually referred to as paper refeed registration taking.

After the paper refeed registration taking is performed, the refeed roller 264 is started so as to convey the sheet onto the paper feed path 266 again with the front and rear sides of the sheet reversed. Subsequent image forming operations are the same as the front surface image forming operations described above, and therefore are not described here.

The sheet having the images being thus formed on both the front and the back surfaces is conveyed to the sheet cutting device B as it is, with the conveyance path switched toward the paper discharge path 258 side by the discharge flapper 257.

With the above operation, the present exemplary embodiment enables the automatic image formation on both surfaces of the sheet without the operator having to re-set the front and rear sides of the sheet.

The scanner unit A2 is provided with a platen 17 on which an image original document is placed, a carriage 18 for reciprocating along the platen 17, a photoelectric conversion unit 19, and a reduction optical system 20 configured to guide the reflected light from the original document on the platen 17 by the carriage 18 to the photoelectric conversion unit 19.

The photoelectric conversion unit 19 photoelectrically converts the optical output from the reduction optical system 20 into image data and outputs the image data as an electrical signal to the image forming unit Al.

For reading the original document sent from the feeder unit A3, the scanner unit A2 is provided with a running platen 21. The feeder unit A3 is provided with a paper feed tray 22, a paper feed path 23 for guiding the original document fed from the paper feed tray 22 to the running platen 21, and a paper discharge tray 24 configured to store original documents having passed through the running platen 21. When the original document is passing through the running platen 21, the original document fed out from the paper feed tray 22 is read by the carriage 18 and the reduction optical system 20.

### <Configuration of Sheet Cutting Device B>

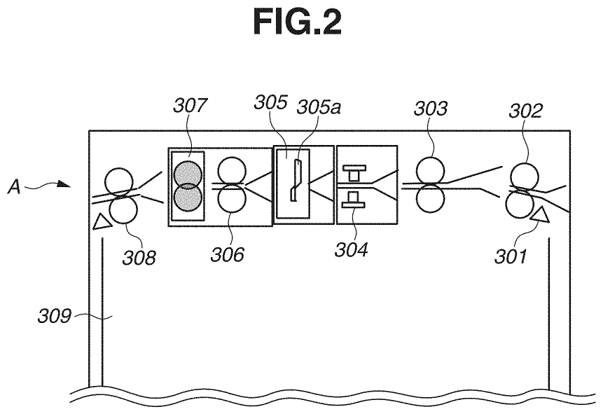

FIG. 2 illustrates in detail a part of the configuration of the sheet cutting device B configured to post-process the sheet conveyed from the image forming device A.

The sheet cutting device B is provided with a leading/rear end cutter unit 305 and a top/bottom cutter unit 307, and the conveyance path connecting the leading/rear end cutter unit 305 and the top/bottom cutter unit 307 extends in a substantially horizontal straight line. The sheet conveyed from the image forming device A is conveyed by the entrance roller 302 to the registration roller 303. When the sheet is conveyed to the registration roller 303, the entrance sensor 301 arranged upstream of the registration roller 303 detects the passage of the sheet.

According to the present exemplary embodiment, the conveyance operation of the registration roller 303 is suspended after a predetermined time elapses from the time when the passage of the sheet is detected by the entrance sensor 301. As a result, the sheet comes into contact with the suspended registration roller 303, and the conveyance is stopped. In that case, the position is fixed so that the end portion of the sheet in the travelling direction is perpendicular to the conveyance path, and when a skew movement occurs because the conveyance direction of the sheet is misaligned relative to the conveyance path, the conveyance path conveyance direction is corrected (paper feed registration taking). After the paper feed registration taking is performed, the registration roller 303 is started so as to convey the sheet to the leading/rear end cutter unit 305.

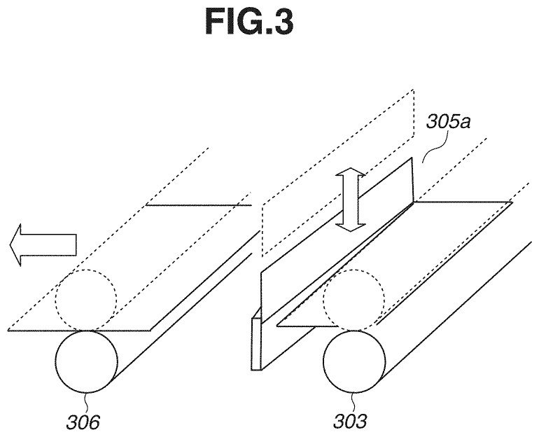

FIG. 3 is a perspective view of the leading/rear end cutter unit 305. The leading/rear end cutter unit 305 is provided with a guillotine blade 305a in a positional relationship across the sheet width in a direction orthogonal to the conveyance direction of the sheet. The guillotine blade 305a is moved up and down by a drive unit (not illustrated) so as to cut the sheet orthogonally to the conveyance direction of the sheet to be conveyed. Based on the cutting position instruction information from the control unit of the image forming device A to be described below, the registration roller 303 temporarily stops the sheet after the sheet has been conveyed by a predetermined feed amount, and the cutting of the sheet is executed at the position. When multiple cuts are to be executed on a single sheet, the registration roller 303 is repeatedly driven/stopped, and then the sheet is conveyed to a downstream process.

The sheet that has been cut by the leading/rear end cutter unit 305 is conveyed by an intermediate roller 306 to the top/bottom cutter unit 307.

When the sheet is not to be cut by the leading/rear end cutter unit 305, the guillotine blade 305a is retreated upward as illustrated in FIG. 3. The direction in which the guillotine blade 305a is retreated is not limited to upward, but may be downward, for example.

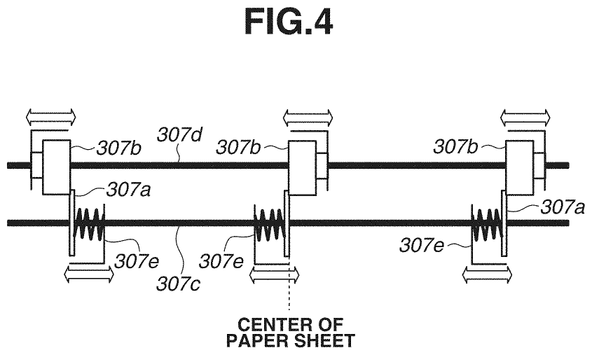

FIG. 4 is a view of the top/bottom cutter unit 307 viewed from a direction A (FIG. 2).

The top/bottom cutter unit 307 is provided with a disk-shaped cutter blade 307a and a cutter blade thrusting member 307b. The disk-shaped cutter blade 307a and the cutter blade thrusting member 307b are supported by a scan shaft 307c and a scan shaft 307d, respectively, and are arranged opposite to the conveyance path. A plurality of disk-shaped cutter blades 307a and a plurality of cutter blade thrusting members 307b are provided in a direction orthogonal to the conveyance direction of the sheet. According to the present exemplary embodiment, one disk-shaped cutter blade 307a and one cutter blade thrusting member 307b are arranged on each of the front side, the center portion, and the rear side, but are not limited thereto.

A drive unit (not illustrated) can move the cutter blade 307a and the cutter blade thrusting member 307b in the direction orthogonal to the conveyance direction of the sheet. For cutting the sheet, the cutter blade 307a in a state of being biased to the cutter blade thrusting member 307b by a biasing spring 307e receives the sheet, and continuously cuts the sheet being conveyed.

As illustrated in FIG. 2, a lateral registration detection sensor 304 is provided upstream of the leading/rear end cutter unit 305, and detects the sheet end portion position in a main scanning direction of the sheet being conveyed. For cutting the sheet with the top/bottom cutter unit 307, the cutter blade 307a and the cutter blade thrusting member 307b, with the detection position of the lateral registration detection sensor 304 as a reference, are moved to the position instructed based on the cutting position instruction information from an image formation control unit A10, and cut the top/bottom sides of the sheet.

The sheet that has been cut by the top/bottom cutter unit 307 is conveyed to the sheet post-processing device C by a paper discharge roller 308. Sheet scraps are generated from the sheets cut by the leading/rear end cutter unit 305 and the top/bottom cutter unit 307. The generated sheet scraps drop to be stored in a scrap box 309.

When the sheet is not to be cut by the top/bottom cutter unit 307, the cutter blade 307a and the cutter blade thrusting member 307b are retreated to a position outside the specified sheet size in accordance with sheet size information from the image formation control unit A10.

### <Configuration of Sheet Post-Processing Device C>

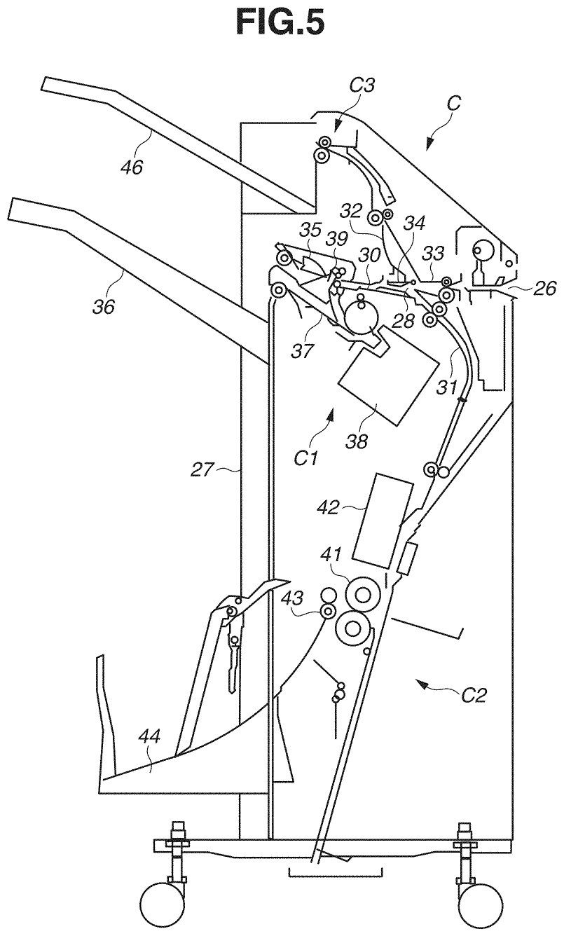

FIG. 5 illustrates a detailed configuration of the sheet post-processing device C configured to post-process a sheet on which an image is formed and which is conveyed from the sheet cutting device B.

The sheet post-processing device C includes a device housing 27 provided with a carry-in port 26 for introducing sheets from the sheet cutting device B. The device housing 27 is positioned so that the carry-in port 26 is communicated to a paper discharge port of the sheet cutting device B. The sheet post-processing device C is provided with a plurality of conveyance rollers configured to convey the sheets introduced into the carry-in port 26.

The sheet post-processing device C is provided with a sheet carry-in path 28 for conveying sheets carried in from the carry-in port 26, a first paper discharge path 30, a second paper discharge path 31 and a third paper discharge path 32, which are branched from the sheet carry-in path 28, a first path switch unit 33, and a second path switch unit 34. The first path switch unit 33 and the second path switch unit 34 each include a flapper guide configured to change the conveyance direction of the sheet being conveyed through the sheet carry-in path 28.

The first path switch unit 33 is shifted by a drive unit (not illustrated) into a mode of guiding the sheet from the carry-in port 26 in the directions of the first and second paper discharge paths 30 and 31, and into a mode of guiding the sheet to the third paper discharge path 32. The first paper discharge path 30 and the second paper discharge path 31 are communicated so that the sheet once introduced into the first paper discharge path 30 can be switched back and conveyed to the second paper discharge path 31 by reversing the conveyance direction.

The second path switch unit 34 is arranged downstream of the first path switch unit 33 with respect to the conveyance direction of the sheet conveyed through the sheet carry-in path 28. The second path switch unit 34 is shifted by a drive unit (also not illustrated) into a mode in which the sheet passing through the first path switch unit 33 is introduced into the first paper discharge path 30 and into a mode in which the sheet once introduced into the first paper discharge path 30 is switched back and conveyed to the second paper discharge path 31.

The sheet post-processing device C includes a first processing unit C1, a second processing unit C2 and a third processing unit C3 configured to execute post-processes different from each other.

The first processing unit C1 executes a binding process of accumulating a plurality of sheets carried out from a paper discharge port 35 at the downstream end of the first paper discharge path 30 with respect to the conveyance direction of the sheet, aligning the sheets into portions, binding the sheets, and discharging the sheets into a loading tray 36 provided on the outside of the device housing 27. The process executed by the first processing unit C1 is referred to as a “first process”.

The first processing unit C1 is provided with a sheet conveyance device 37 configured to convey the sheet or a sheet bundle, and a binding unit 38 configured to bind the sheet bundle. At the downstream end of the first paper discharge path 30, a discharge rollers pair 39 is provided for switching back and conveying the sheet from the first paper discharge path 30 to the second paper discharge path 31 and discharging the sheet from the paper discharge port 35.

The second processing unit C2 bundles a plurality of sheets that is switched back and conveyed from the second paper discharge path 31, and after binding the sheet bundle, folds the sheets. The second processing unit C2 is provided with a folding device 41 configured to fold the carried-in sheets or sheet bundles, and a binding unit 42 that is arranged immediately upstream of the folding device 41 along the conveyance direction of the sheet conveyed to the second paper discharge path 31 and configured to bind the sheet bundles. The folded sheet bundle is discharged by a discharge roller 43 to a loading tray 44 provided on the outside of the device housing 27. The process executed by the second processing unit C2 is referred to as a “second process”.

The third processing unit C3 executes jog sorting to classify the sheets, which are conveyed from the third paper discharge path 32, into a group of sheets to be accumulated with a predetermined amount of offset in the direction orthogonal to the conveyance direction and a group of sheets to be accumulated without offset. The jog-sorted sheets are discharged to a loading tray 46 provided on the outside of the device housing 27, where the offset and non-offset sheet bundles are stacked. The process executed by the third processing unit C3 is referred to as a “third process”.

### <Control Block Diagram of Image Forming System>

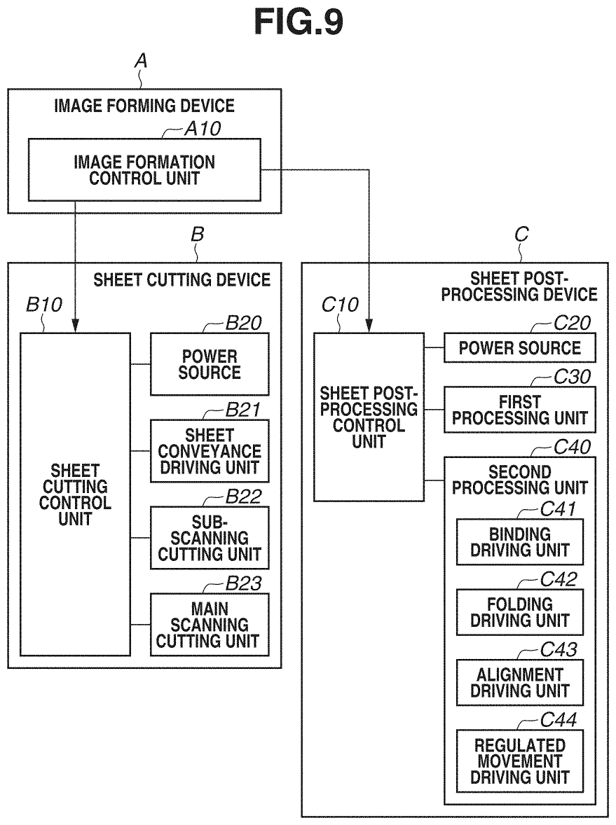

FIG. 9 is a control block diagram of the image forming device A, the sheet cutting device B, and the sheet post-processing device C, which constitute the image forming system 100. The image forming device A, the sheet cutting device B, and the sheet post-process device C include the image formation control unit A10, a sheet cutting control unit B10, and a sheet post-processing control unit C10, respectively.

The sheet cutting control unit B10 controls the operations of a power supply B20, a sheet conveyance driving unit B21, a sub-scanning cutting unit B22, and a main scanning cutting unit B23. The sheet post-processing control unit C10 controls the operations of a power supply C20, a first processing unit C30, and a second processing unit C40 (a binding driving unit C41, a folding driving unit C42, an alignment driving unit C43, and a regulated movement driving unit C44).

The sheet cutting control unit B10 and the sheet post-processing control unit C10 receive an instruction from the image formation control unit A10, such as sheet size information, basis weight information, paper type information, number of sheets information, and a cut amount, and perform a cutting process and a folding process at the desired timing and position.

<Selection of Discharge Destination according to Sheet Size>

Hereinafter described in detail is the configuration for changing the paper discharge destination according to the size of the cut sheet, which is a feature of the present exemplary embodiment.

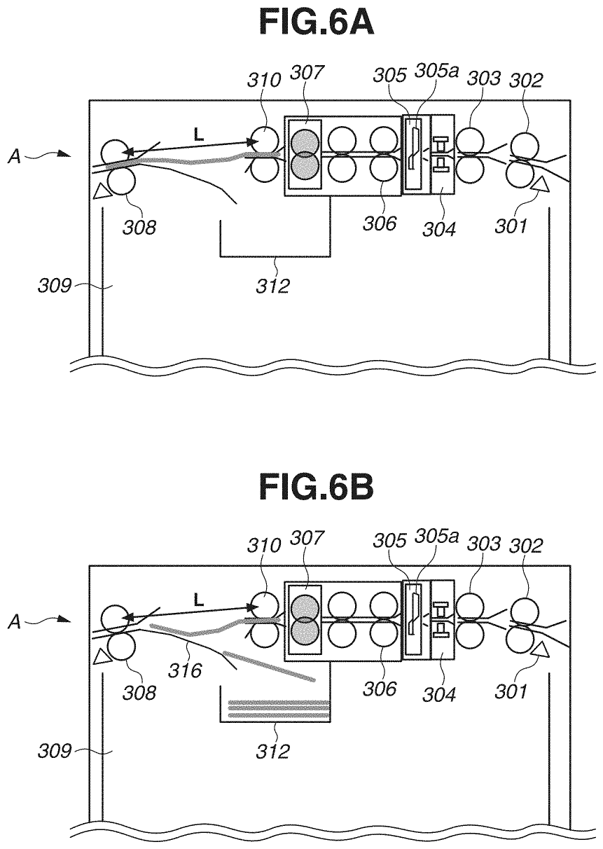

As one example of products to be made, a case of making a product in a fringeless saddle-stitched shape from an A4 size (210 mm×297 mm) sheet, and a case of making ten product having a size of a business card from the above-described sheet will be described, with reference to FIGS. 6A and 6B. FIGS. 6A and 6B are each a detailed view of a portion of the sheet cutting device B according to the first exemplary embodiment.

Description will be provided about the case of making the fringeless saddle-stitched products.

The A4 size sheet printed by the image forming device A is conveyed to the sheet cutting device B in a direction along the long side of the sheet (297 mm) as the conveyance direction. The leading/rear end cutter unit 305 cuts the leading end and rear end in the conveyance direction of the sheet by about 5 mm each so as to cut a margin on a fore edge side. The top/bottom cutter unit 307 cuts the top/bottom sides of the sheet by about 5 mm as well. The sheet, which has been cut on four sides and has no fringe, is conveyed by a post-cut conveyance pair of rollers 310 provided in the sheet cutting device B, and is received by the paper discharge roller 308 arranged at a predetermined distance L further downstream of the post-cut conveyance pair of rollers 310. According to the present exemplary embodiment, a roller pitch L between the post-cut conveyance pair of rollers 310 and the paper discharge roller 308 is assumed to be 70 mm.

The cut sheet that has become fringeless is about 287 mm because the leading end and rear end in the conveyance direction are cut by about 5 mm. Since the roller pitch L between the post-cut conveyance pair of rollers 310 and the paper discharge roller 308 is 70 mm, when the post-cut size is 287 mm, the sheet is received by the paper discharge roller 308 and further conveyed to the sheet post-processing device C, as illustrated in FIG. 6A. The sheet received by the sheet post-processing device C is folded and bound, and discharged to the loading tray 44.

Description will be provided about the case of making business-card-sized products.

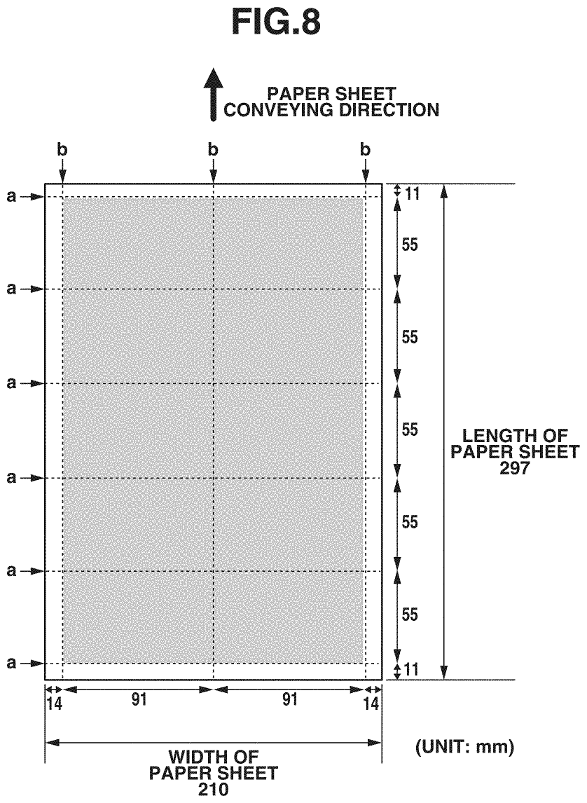

The A4 size sheet printed by the image forming device A is conveyed to the sheet cutting device B in a direction along the long side of the sheet (297 mm) as the conveyance direction. As illustrated in FIG. 8, the leading/rear end cutter unit 305 cuts the leading end portion by 11 mm, and cuts the leading end portion five times at a 55 mm pitch. The top/bottom cutter unit 307 cuts the sheet cut to have a 55 mm width by about 14 mm on each of top and bottom portions and one center portion. By the above operation, the A4 size sheet is cut into 10 business card size (55 mm×91 mm) sheets.

The cut sheets are conveyed by the post-cut conveyance pair of rollers 310, and are conveyed in the direction toward the paper discharge roller 308. Here, according to the present exemplary embodiment, the roller pitch L is set to 70 mm, which is longer than the length of the short side of the business card size (55 mm). For this reason, as illustrated in FIG. 6B, the sheet cut to have a 55 mm width is not passed to the paper discharge roller 308, but is discharged to a small-size product paper discharge tray 312 via a slope face 316 and loaded in the small-size product paper discharge tray 312. Accordingly, the sheet cut to have a 55 mm width is not conveyed to the sheet post-processing device C. A plurality of conveyance rollers for conveying sheets is arranged in the sheet post-processing device C. The interval (roller pitch) in the conveyance direction between adjacent conveyance rollers of the sheet post-processing device C is longer than 55 mm. According to the present exemplary embodiment, the interval (roller pitch) in the conveyance direction between adjacent conveyance rollers of the sheet post-processing device C is set to 70 mm.

In this way, according to the first exemplary embodiment, it is possible to make small business-card-sized products without reducing the roller pitch from the receiving portion to the paper discharge portion in the sheet post-processing device C and without complicating the device.

In the above description, the roller pitch L between the post-cut conveyance pair of rollers 310 and the paper discharge roller 308 is set to 70 mm, and the A4 size products and the business card size products are used as examples for explanation. However, the roller pitch L is not limited to 70 mm, and the destinations of variously sized products are switchable according to the roller pitch L.

<Flow from Image Formation to Discharge>

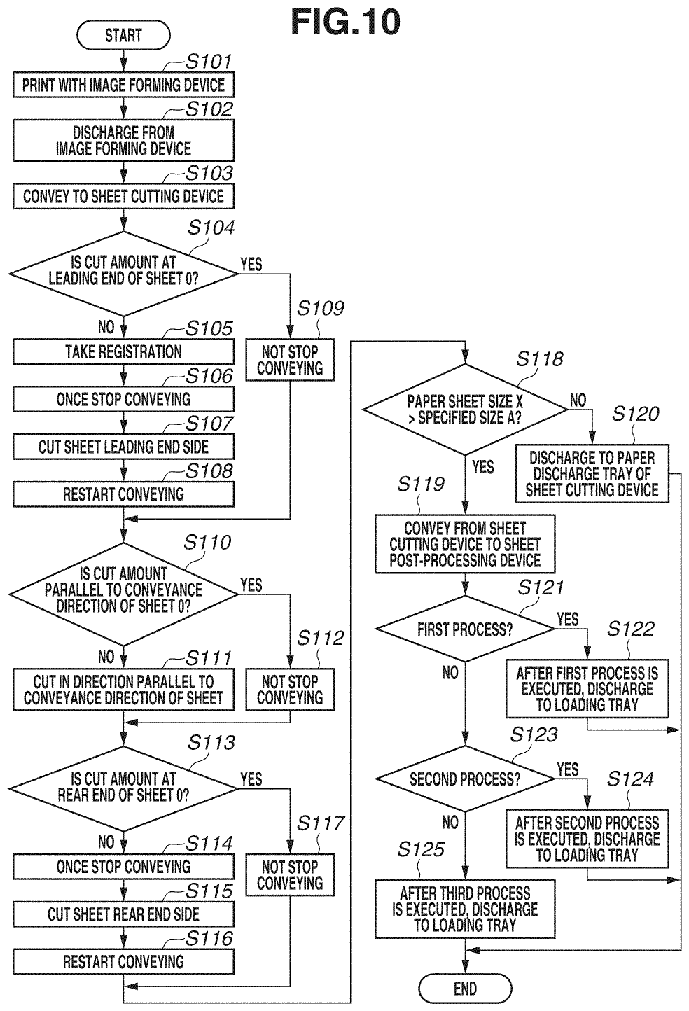

FIG. 10 is a flowchart illustrating the overall flow of operations from image formation to cutting and folding. Using a program recorded in the image forming device A, the following processes are executed based on an instruction from the image formation control unit A10.

After the image is formed on the sheet by the image forming device A in step S101, in step S102, the sheet on which the image is formed is discharged from the image forming device A. In step S103, the sheet discharged from the image forming device A is conveyed to the sheet cutting device B.

When the sheet is conveyed to the sheet cutting device B, in step S104, it is determined whether the cut amount at the leading end of the sheet, which is in the direction orthogonal to the conveyance direction of the sheet, is 0.

In a case where the cut amount at the leading end of the sheet is not zero (NO in step S104), in step S105, the registration roller 303 executes the paper feed registration taking. After the sheet conveyance is once stopped at the position where the sheet is conveyed from the sheet leading end by the sheet leading end cut amount instructed by the image formation control unit A10 in step S106, in step S107, cutting of the sheet leading end side, which is a direction orthogonal to the sheet conveyance direction, is executed. After the cutting process of the leading end side is executed, the sheet conveyance is restarted in step S108, and the sheet is conveyed to the top/bottom cutter unit 307.

In a case where the cut amount at the leading end of the sheet is 0 (YES in step S104), no paper feed registration taking or no cutting is executed, and in step S109, the sheet is conveyed to the top/bottom cutter unit 307, without stopping the sheet conveyance.

When the sheet is conveyed to the top/bottom cutter unit 307, in step S110, it is determined whether the cut amount in the direction parallel to the conveyance direction of the sheet is 0.

In a case where the cut amount in the direction parallel to the conveyance direction of the sheet is not 0 (NO in step S110), in step S111, the cutter blade 307a which has entered the sheet by the cut amount instructed by the image formation control unit A10 executes cutting in the direction parallel to the conveyance direction of the sheet being conveyed.

In a case where the cut amount in the direction parallel to the conveyance direction of the sheet is 0 (YES in step S110), in step S112, the sheet is conveyed with the cutter blade 307a retreated to a home position (not illustrated) outside the sheet width.

In step S113, it is determined whether the cut amount at the rear end of the sheet, which is a direction orthogonal to the conveyance direction of the sheet, is 0.

In a case where the cut amount at the rear end of the sheet is not 0 (NO in step S113), the sheet conveyance is once stopped at a position where the cut amount at the rear end instructed by the image formation control unit A10 is left in step S114, and then in step S115, cutting of the sheet rear end side, which is a direction orthogonal to the sheet conveyance direction, is executed. After execution of the cutting process of the rear end side, in step S116, the sheet conveyance is restarted.

In a case where the cut amount at the rear end of the sheet is 0 (YES in step S113), in step S117, the sheet conveyance is continued without being stopped.

In step S118, a comparison is made between the size of the cut sheet, and a predetermined size (hereinafter referred to as “specified size”).

In a case where the size of the cut sheet is larger than the specified size (YES in step S118), specifically, in a case where a length X of the cut sheet in the conveyance direction of the sheet is longer than the specified length A (A=70 mm according to the present exemplary embodiment), in step S119, the sheet is discharged from the sheet cutting device B and is conveyed to the sheet post-processing device C.

In a case where the size of the cut sheet is smaller than or equal to the specified size (NO in step S118), specifically, in a case where the length X of the cut sheet in the conveyance direction of the sheet is shorter than or equal to the specified length A, in step S120, the sheet is discharged to the small-size product paper discharge tray 312 provided in the sheet cutting device B.

The sheet conveyed to the sheet post-processing device C is processed by the sheet post-processing device C based on the instruction from the image formation control unit A10.

First, in step S121, it is determined whether an instruction from the image formation control unit A10 is for the first process described above. In a case where the instruction is for the first process (YES in step S121), the sheet is conveyed to the first processing unit C1, the first process is executed, and the sheet is discharged to the loading tray 36, in step S122.

In a case where the instruction is not for the first process (NO in step S121), in step S123, it is determined whether the instruction from the image formation control unit A10 is for the second process described above. In a case where the instruction is for the second process (YES in step S123), the sheet is conveyed to the second processing unit C2, the second process is executed, and the sheet is discharged to the loading tray 44, in step S124. The sheet discharged to the loading tray 44 is loaded on the loading tray 44. In a case where the instruction is not for the second process (NO in step S123), it is determined that the instruction from the image formation control unit A10 is for the third process described above, and the sheet is conveyed to the third processing unit C3, the third process is executed, and the sheet is discharged to the loading tray 46 (S125). The sheet discharged to the loading tray 46 is loaded on the loading tray 46.

A second exemplary embodiment is characterized in that, unlike the first exemplary embodiment, the conveyance path switch unit 313 is used when the post-cutting conveyance destination is to be changed depending on the cut sheet size.

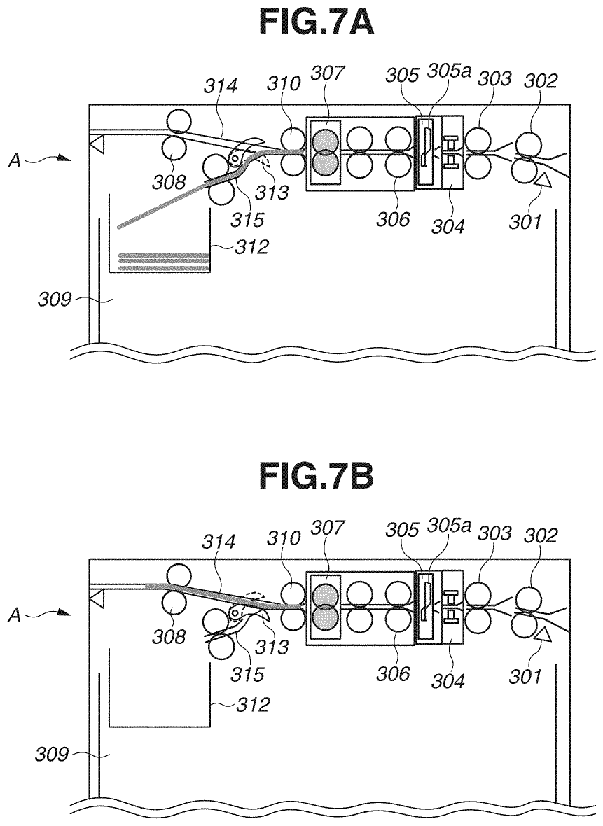

In the following, as one example of products to be made, a case of making products having a fringeless saddle-stitched shape from an A4 size (210 mm×297 mm) sheet, and a case of making ten products having a size of a business card from the above-described sheet will be described, with reference to FIGS. 7A and 7B. FIGS. 7A and 7B each are a detailed view of a portion of the sheet cutting device B according to the second exemplary embodiment. Any description overlapping with that of the first exemplary embodiment will be omitted.

Description will be provided about the case of making the fringeless saddle-stitched products.

The A4 size sheet printed by the image forming device A is conveyed to the sheet cutting device B in a direction along the long side (297 mm) as the conveyance direction. The leading/rear end cutter unit 305 cuts the leading end and the rear end in the conveyance direction of the sheet by about 5 mm each to cut a margin on a fore edge side. The top/bottom cutter unit 307 cuts the top/bottom sides by about 5 mm as well.

The sheet, which has been cut on four sides and has no fringe, is conveyed by the post-cut conveyance pair of rollers 310 provided in the sheet cutting device B. Here, according to the second exemplary embodiment, a conveyance path switch unit 313 provided downstream of the post-cut conveyance pair of rollers 310 is configured to be switchable to a first post-cut conveyance path 314 and a second post-cut conveyance path 315. Based on the instruction from the image formation control unit A10, as illustrated in FIG. 7B, the cut sheet that has become fringeless is conveyed to the first post-cut conveyance path 314 by the conveyance path switch unit 313.

The cut sheet that has become fringeless is further conveyed to the sheet post-processing device C. The sheet received by the sheet post-processing device C is folded and bound, and discharged to the loading tray 44.

Description will be provided about the case of making the business-card-sized products.

The A4 size sheet printed by the image forming device A is conveyed to sheet cutting device B in a direction along the long side of the sheet (297 mm) as the conveyance direction. As illustrated in FIG. 8, the leading/rear end cutter unit 305 cuts the leading end portion by 11 mm, and cuts the sheet five times at a 55 mm pitch. The top/bottom cutter unit 307 cuts the sheet cut to have a 55 mm width by about 14 mm on each of top and bottom portions and one center portion. In the above operation, the A4 size sheet is cut into 10 business card size (55 mm×91 mm) sheets.

The cut sheet is conveyed by the post-cut conveyance pair of rollers 310. Based on the instruction from the image formation control unit A10, as illustrated in FIG. 7A, the conveyance path switch unit 313 provided downstream of the post-cut conveyance pair of rollers 310 discharges the sheet, via the second post-cut conveyance path 315, to the small-size product paper discharge tray 312 provided in the sheet cutting device B. For this reason, the sheet cut to have a 55 mm width is not conveyed to the sheet post-processing device C.

In this way, according to the second exemplary embodiment, it is possible to make small business-card-sized products without reducing the roller pitch from the receiving portion to the paper discharge portion in the sheet post-processing device C and without complicating the device.

The present disclosure can also be realized by a process where a program, which realizes one or more functions of the above exemplary embodiments, is supplied to a system or device via a network or storage medium, and one or more processors in a computer of the system or device read and execute the program. The present disclosure can also be realized by a circuit (e.g., application specific integrated circuit (ASIC)) that realizes one or more functions.

The present disclosure may be applied to a system including a plurality of devices or to a device including a single device.

The present disclosure is not limited to the above exemplary embodiments, and various variations are possible based on the purpose of the present disclosure, and such variation are not excluded from the scope of the present disclosure. That is, all configurations that combine the above configuration examples and variations thereof are included in the present disclosure. Any of the above exemplary embodiments makes it possible to make small products without complicating the device.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2020-187776, filed Nov. 11, 2020, which is hereby incorporated by reference herein in its entirety.

What is claimed is:

1. An image forming system comprising:
a first unit including an image forming unit configured to form an image on a sheet fed from a feed unit;
a second unit arranged on a downstream side of the first unit and including a cutting unit configured to cut the sheet on which the image is formed by the image forming unit; and
a third unit arranged on a downstream side of the second unit and including a post-processing unit configured to post-process the sheet cut by the cutting unit,
wherein a sheet cut to have a first size is discharged to a first discharge unit provided in the second unit, and
wherein a sheet cut to have a second size larger than the first size is discharged to a second discharge unit provided in the third unit.

2. The image forming system according to claim 1,
wherein a sheet cut to have a first length in a conveyance direction of the sheet is discharged to the first discharge unit, and
wherein a sheet cut to have a second length longer than the first length in the conveyance direction of the sheet is discharged to the second discharge unit.

3. The image forming system according to claim 2,
wherein the first length is a length of a short side of a business card size, and
wherein the second length is a length of a long side of an A4 sheet.

4. The image forming system according to claim 1, wherein the cutting unit is configured to cut the sheet in a direction orthogonal to a conveyance direction of the sheet.

5. The image forming system according to claim 1, wherein the post-process includes a process of binding the sheet.

6. The image forming system according to claim 1, wherein the post-process includes a process of binding the sheet and a process of folding the sheet.

7. The image forming system according to claim 1, wherein the second unit includes a first roller arranged on a downstream side of the cutting unit and a second roller arranged on a downstream side of the first roller.

8. The image forming system according to claim 7, wherein the sheet cut to have the first size is discharged from between the first roller and the second roller to the first discharge unit.

9. The image forming system according to claim 8, wherein the sheet cut to have the second size is conveyed to the third unit via the first roller and the second roller.

10. The image forming system according to claim 1, wherein the second unit includes a switch unit configured to switch a conveyance destination of the sheet in a manner to guide the sheet cut to have the first size toward the first discharge unit and to guide the sheet cut to have the second size toward the third unit.

11. The image forming system according to claim 10, wherein the switch unit is configured to switch a conveyance path of the cut sheet based on an instruction from a control unit included in the first unit.

12. An image forming system comprising:
a first unit including an image forming unit configured to form an image on a sheet fed from a feed unit;
a second unit arranged on a downstream side of the first unit and including a cutting unit configured to cut the sheet on which the image is formed by the image forming unit; and
a third unit arranged on a downstream side of the second unit and including a post-processing unit configured to post-process the sheet cut by the cutting unit,
wherein in a case where a sheet is cut to have a first length in a conveyance direction of the sheet, the cut sheet is discharged to a first discharge unit provided in the second unit, and
wherein in a case where a sheet is cut to have a second length longer than the first length in the conveyance direction of the sheet, the cut sheet is discharged to a second discharge unit provided in the third unit.

13. The image forming system according to claim 12,
wherein the second unit includes a first roller arranged on a downstream side of the cutting unit and a second roller arranged on a downstream side of the first roller,
wherein a distance between the first roller and the second roller in the conveyance direction is longer than the first length, and
wherein in a case where a sheet is cut to have the first length in the conveyance direction of the sheet, the cut sheet is moved toward the first discharge unit from between the first roller and the second roller.

14. A control method for controlling an image forming system including:
a first unit including an image forming unit configured to form an image on a sheet fed from a feed unit,
a second unit arranged on a downstream side of the first unit and including a cutting unit configured to cut the sheet on which the image is formed by the image forming unit, and
a third unit arranged on a downstream side of the second unit and including a post-processing unit configured to post-process the sheet cut by the cutting unit,
the control method comprising:
discharging a sheet cut to have a first size to a first discharge unit provided in the second unit; and
discharging a sheet cut to have a second size larger than the first size to a second discharge unit provided in the third unit.

15. A method for an image forming system having a first unit including an image forming unit, a second unit arranged on a downstream side of the first unit and including a cutting unit, and a third unit arranged on a downstream side of the second unit and including a post-processing unit, the method comprising:
forming, via the image forming unit of the first unit, an image on a sheet fed from a feed unit;
cutting, via the cutting unit of the second unit, the sheet on which the image is formed by the image forming unit;
post-processing, via the post-processing unit of the third unit, the sheet cut by the cutting unit;
discharging a sheet cut to have a first size to a first discharge unit provided in the second unit; and
discharging a sheet cut to have a second size larger than the first size to a second discharge unit provided in the third unit.
